(19) United States
(12) Patent Application Publication
(10) Pub. No.: US 2012/0005103 A1
(43) Pub. Date: Jan. 5, 2012

(54) METHOD AND APPARATUS FOR CONSTRUCTION SIMULATION

(75) Inventors: Hiroshi Seki, Naka (JP); Takeshi Yokota, Hitachi (JP)

(73) Assignee: HITACHI, LTD.

(21) Appl. No.: 13/173,167

(22) Filed: Jun. 30, 2011

(30) Foreign Application Priority Data
Jun. 30, 2010 (JP) 2010-148469

(51) Int. Cl. G06Q 10/00

(52) U.S. Cl. 705/301

(57) ABSTRACT

In a construction simulation apparatus: a 3-D already-existing model, installation progress data, and a 3-D new-construction model are recorded in databases; a match determination unit determines similarity in one or more installation positions of one or more of pieces of equipment and piping components between the 3-D already-existing model and the 3-D new-construction model; and a progress selection unit selects, as portions of installation schedule data corresponding to the 3-D new-construction model, portions of the installation progress data corresponding to matching portions of the 3-D already-existing model, on the basis of data indicating a correspondence relationship between the 3-D already-existing model and the installation progress data, where the matching portions of the 3-D already-existing model are extracted by the match determination unit and respectively match the portions of the 3-D new-construction model.

### CROSS REFERENCE TO RELATED APPLICATION

This application claims priority under 35 U.S.C. §119 to Japanese Patent Application No. 2010-148469 filed on Jun. 30, 2010, the disclosure of which is incorporated herein by reference.

### BACKGROUND OF THE INVENTION

1. Field of the Invention

The present invention relates to support for producing installation schedule data based on CAD (computer aided design) data or engineering data in the fields relating to design engineering, procurement, and construction of plants.

2. Description of the Related Art

For example, before starting construction of power plants such as nuclear or thermal power plants, it is necessary to draw up a plan corresponding to complicated installation of piping and equipment as well as a building which contains facilities for power generation.

In recent years, 3-D (three-dimensional) CAD data and electronic schedule data have been frequently used for drawing up a construction plan. Estimation of members necessary for construction has been enabled by summarizing 3-D CAD data and related attribute data, and automatic summation of estimated man-hours has also been enabled by electronically utilizing schedule data.

However, data in the earliest stage in a process is required to be produced by the planner, and it takes much time to produce such data even for experts having rich experience and know-how in construction.

According to the method for support for making a construction schedule disclosed in Japanese Patent Laid-open No. 2005-18673 (JP 2005-18673 A), in many takt schedules of construction works, the structure building methods adopted in elevation & construction divisions and the attributes of members included in the elevation & construction divisions are completely identical even when the execution quantities in the elevation & construction divisions are different. In such cases, the takt schedules (including necessary operations, operation names, and procedures) also become identical. Therefore, JP 2005-18673 A discloses production, as the “basic takt schedule,” of a takt schedule which can be used in elevation & construction divisions in common in the case where a completely identical structure building method is adopted in the elevation & construction divisions and completely identical attributes of members are included in the elevation & construction divisions.

As described above, it is possible to produce, for example, a construction schedule for an ordinary building on the basis of the quantities of materials and the installation methods which are arranged in advance. However, in the case where complicated installation of piping and equipment is required as in the cases of nuclear and thermal power plants, it is difficult to produce a detailed installation schedule for a plant to be newly constructed, by utilizing installation procedures and the amounts of man-hours corresponding to the complicated installation. Since the operations of logically analyzing installation progress data and processing the analyzed result need time and manpower, conventionally the automatic schedule planning by use of a database of the quantities of installed materials and the amount of man-hours for work has been only partially applied.

### SUMMARY OF THE INVENTION

The present invention provides a construction simulation apparatus including: a first database in which a three-dimensional design model of an already-constructed plant (which is hereinafter referred to as the 3-D already-existing model) is recorded; a second database in which installation progress data obtained during construction of the already-constructed plant is recorded; a third database in which a three-dimensional design model of a plant to be newly constructed (which is hereinafter referred to as the 3-D new-construction model) is recorded; a match determination unit which determines similarity in one or more installation positions of one or more of pieces of equipment and piping components in a building between the 3-D already-existing model and the 3-D new-construction model on the basis of comparison of the 3-D already-existing model and the 3-D new-construction model; and a progress selection unit which selects, as one or more portions of installation schedule data corresponding to the 3-D new-construction model, one or more portions of the installation progress data corresponding to one or more matching portions of the 3-D already-existing model, on the basis of data indicating a correspondence relationship between the 3-D already-existing model and the installation progress data, where the one or more matching portions of the 3-D already-existing model are extracted by the match determination unit and respectively match the one or more portions of the 3-D new-construction model.

According to the construction simulation apparatus of the present invention, it is possible to produce a detailed installation schedule for a plant to be newly constructed, by utilizing installation procedures and the amounts of man-hours corresponding to the complicated installation.

### BRIEF DESCRIPTION OF THE DRAWINGS

FIG. 1 illustrates a configuration of the construction simulation apparatus according to an embodiment of the present invention;

FIG. 2 is a diagram illustrating a configuration of the schedule-pattern determination unit in the construction simulation apparatus;

FIG. 3 is a diagram illustrating a configuration of the 3-D similarity comparison unit in the schedule-pattern determination unit in the construction simulation apparatus;

FIG. 4 is a flow diagram indicating a flow of processing performed by the 3-D similarity comparison unit for determining the similarity in the equipment arrangement;

FIG. 5 is a diagram indicating examples of equipment specifications which are used in the determination of similarity of equipment arrangement;

FIGS. 6A and 6B are diagrams indicating examples of equipment sizes and coordinates of installation positions which are used in the determination of similarity of equipment arrangement;

FIG. 7 is a flow diagram indicating a flow of processing for determining the similarity in the piping route;

FIGS. 8A and 8B are diagrams indicating examples of piping-route numbers and piping specifications which are used in the determination of similarity of piping routes;

FIGS. 9A and 9B are diagrams illustrating examples of three-dimensional arrangement of the connection points (explained with reference to FIGS. 8A and 8B) which are used for determination of similarity of the piping routes based on the equipment numbers of the pieces of equipment connected to the piping routes;

FIG. 10 is a diagram illustrating an example of installation progress data obtained during construction of an already-constructed plant;

FIG. 11 is a diagram indicating a flow of processing for selecting one or more portions of installation progress data;

FIG. 12 is a diagram illustrating an example of selection of one or more portions of the installation progress data by using grouping of 3-D components;

FIG. 13 is a diagram illustrating a table indicating examples of rules based on empirical knowledge, which is used in the selection of the installation progress data;

FIG. 14 is a diagram indicating a flow of processing for determining one or more portions of an installation schedule to which no portion of the installation progress data is assigned;

FIG. 15 is a diagram illustrating a configuration of the schedule combining unit;

FIG. 16 is a diagram illustrating an example of a WBS (work breakdown structure) template;

FIG. 17 is a diagram indicating a flow of processing for allocating the quantity;

FIG. 18 is a diagram illustrating auxiliary information for use in additional man-hour calculation;

FIG. 19 is a diagram indicating a flow of processing for production of one or more partial installation schedules;

FIG. 20 is a diagram indicating a flow of processing for combining the one or more partial installation schedules; and

FIG. 21 is a diagram illustrating an example of a screen for displaying an installation schedule produced by the combining.

### DETAILED DESCRIPTION OF THE PREFERRED EMBODIMENT

The embodiment explained below is an example in which matching portions of design data (including equipment specifications, piping routes, and welding points) of a plant to be newly constructed and an already-constructed plant are determined, and an installation schedule of the plant to be newly constructed is automatically produced on the basis of installation progress data obtained during construction of the already-constructed plant, where a means for automatically producing the installation schedule is provided in the embodiment.

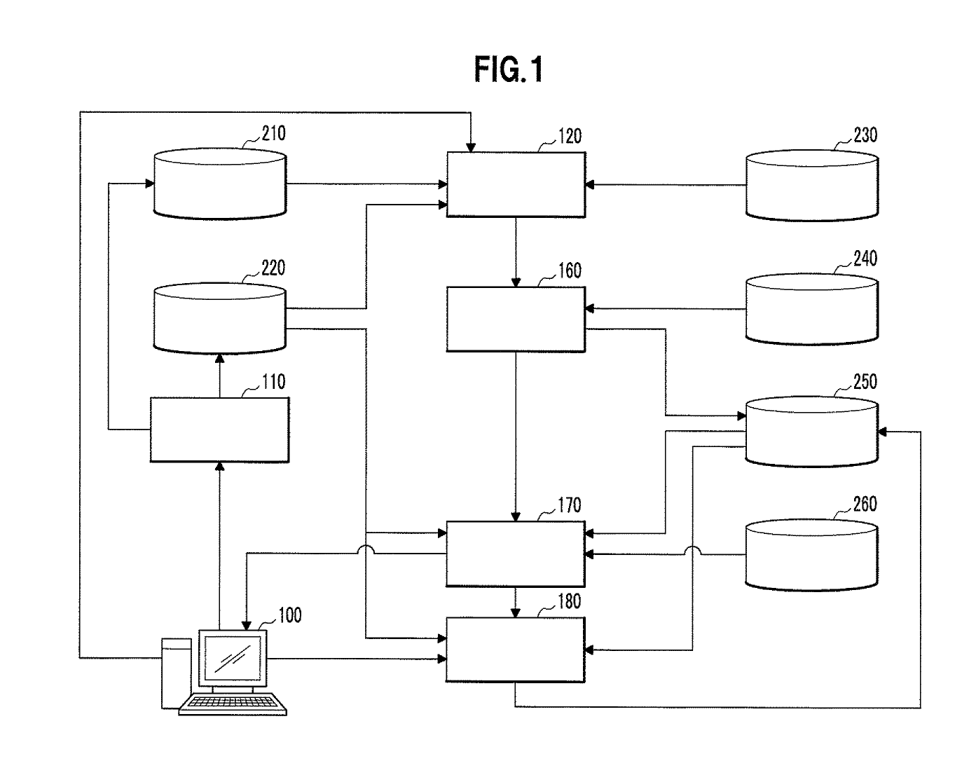

### 1. CONFIGURATION OF APPARATUS (FIGS. 1 TO 3)

FIG. 1 illustrates a configuration of the construction simulation apparatus according to the embodiment of the present invention. The construction simulation apparatus of FIG. 1 includes an input/output device 100, a 3-D (three-dimensional) CAD (computer aided design) system 110, a schedule-pattern determination unit 120, a schedule combining unit 160, a validity confirmation unit 170, and a schedule editor 180. In addition, in order to acquire data as material for production of the installation schedule, the construction simulation apparatus of FIG. 1 uses a 3-D database 210 on the already-constructed plant, a 3-D database 220 on the plant to be newly constructed, a database 230 on the installation progress data, a schedule-template database 240, a schedule database 250, and a milestone database 260.

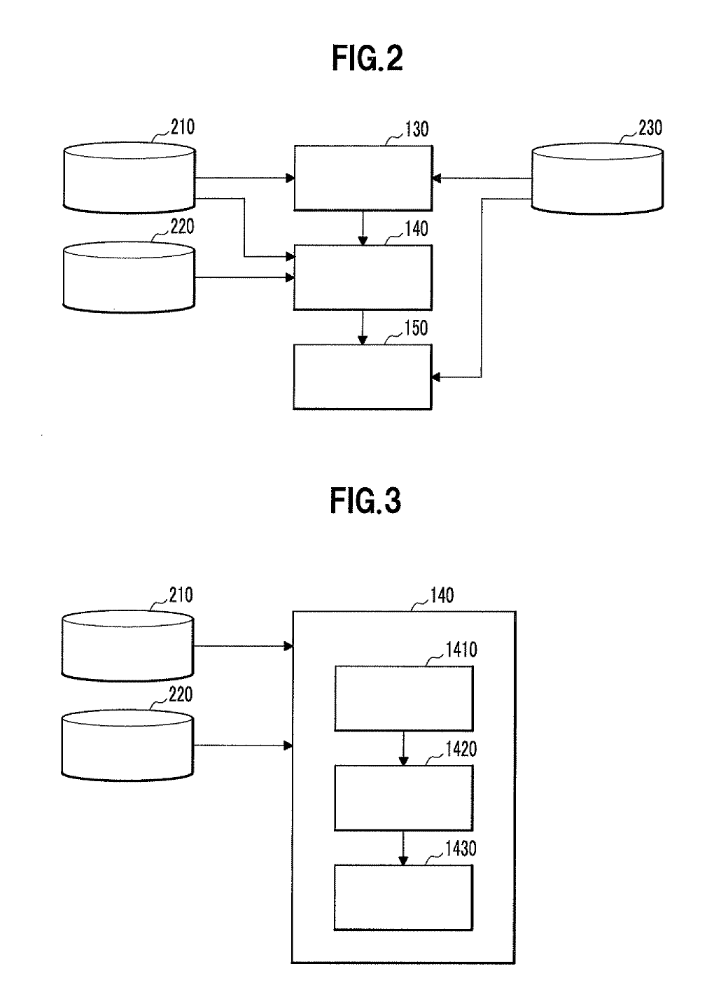

FIG. 2 is a diagram illustrating a configuration of the schedule-pattern determination unit 120 in the construction simulation apparatus. Specifically, the schedule-pattern determination unit 120 includes a part-activity association unit 130, a 3-D similarity comparison unit 140, and a progress-data extraction unit 150.

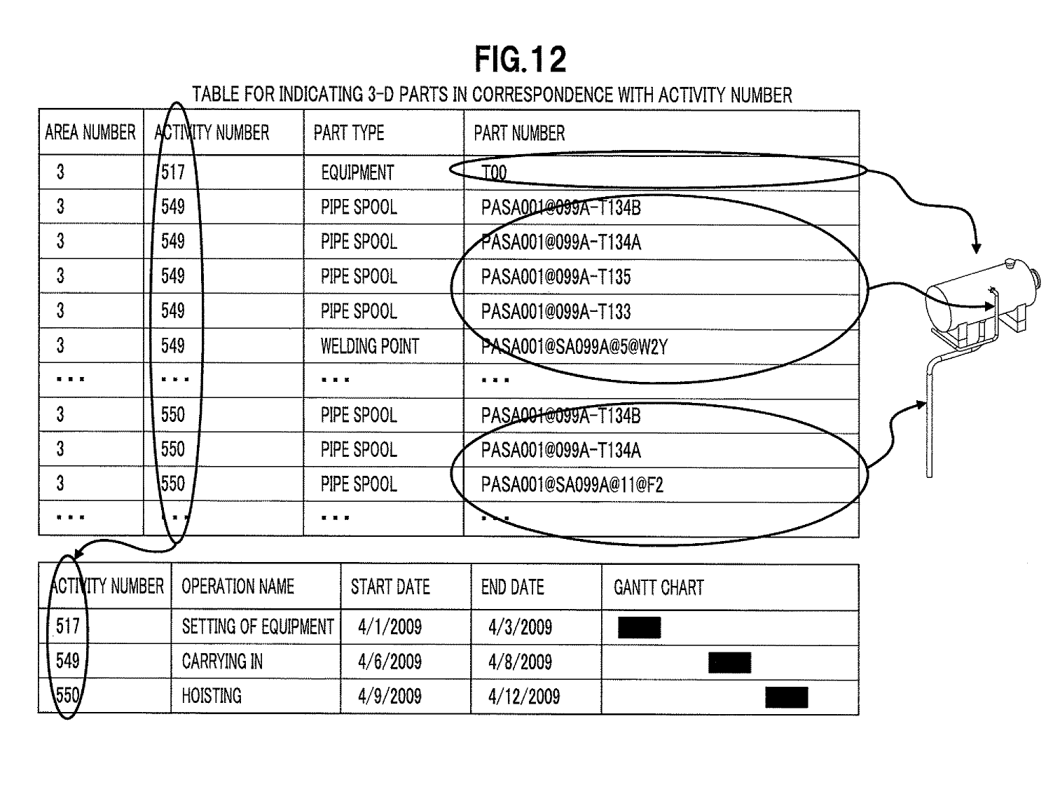

The part-activity association unit 130 is used in the processing performed by the progress-data extraction unit 150, and will be explained later with reference to FIG. 12.

FIG. 3 is a diagram illustrating a configuration of the 3-D similarity comparison unit 140 in the schedule-pattern determination unit 120 in the construction simulation apparatus. The 3-D similarity comparison unit 140 determines the similarity of the three-dimensional installation positions. The 3-D similarity comparison unit 140 includes an equipment-position comparator 1410 and a piping-route comparator 1420. The 3-D similarity comparison unit 140 uses the equipment-arrangement comparator 1410 and the piping-route comparator 1420, and outputs comparison results 1430. As explained later in the following sections 2 and 3, the 3-D similarity comparison unit 140 can use one or both of the equipment-position comparator 1410 and the piping-route comparator 1420.

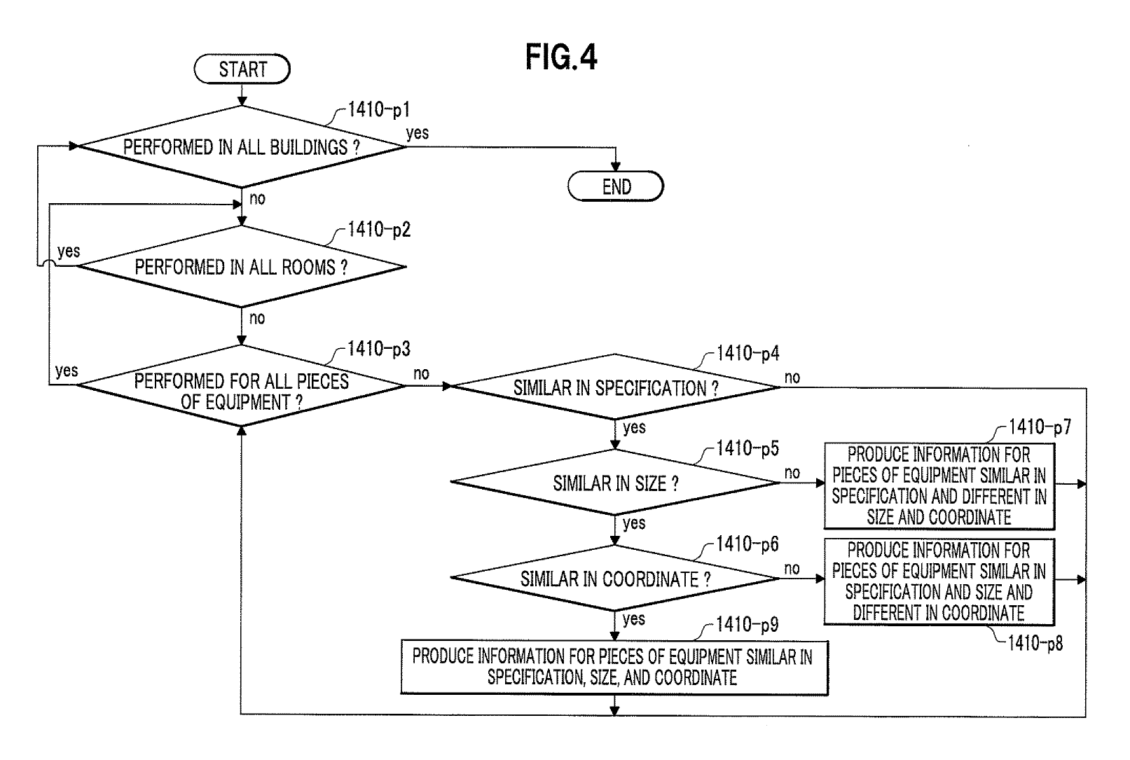

### 2. COMPARISON OF INSTALLATION POSITIONS FOR SIMILARITY (FIGS. 4 TO 6)

FIG. 4 is a flow diagram indicating a flow of processing performed by the 3-D similarity comparison unit 140 for determining the similarity in the equipment arrangement. In the processing of FIG. 4, the operations for all pieces of equipment (in the loop beginning from step 1410-p3) in all rooms (in the loop beginning from step 1410-p2) in all buildings (in the loop beginning from step 1410-p1) are performed, so that the pieces of equipment are sorted into the following three groups 1) to 3):

1) pieces of equipment which are similar in all of the equipment specification, the size, and the coordinates of the installation position (through steps 1410-p4, -p5, and -p6);

2) pieces of equipment which are similar in both of the equipment specification and the size, and different in the coordinates of the installation position (through steps 1410-p4, -p5, and -p6); and

3) pieces of equipment which are similar in the equipment specification and different in the size and the coordinates of the installation position (through steps 1410-p4, and -p5). Then, the 3-D similarity comparison unit 140 produces for each of the above groups information defining a different way of use of the installation progress data (in steps 1410-p9, -p8, or -p7).

Alternatively, the similarity may be determined on the basis of one or more of the equipment specification, the size, and the coordinates of the installation position. In addition, the similarity may be determined on the basis of whether or not each of the equipment specification, the size, and the coordinates of the installation position falls within a predetermined range, or by use of a predetermined function.

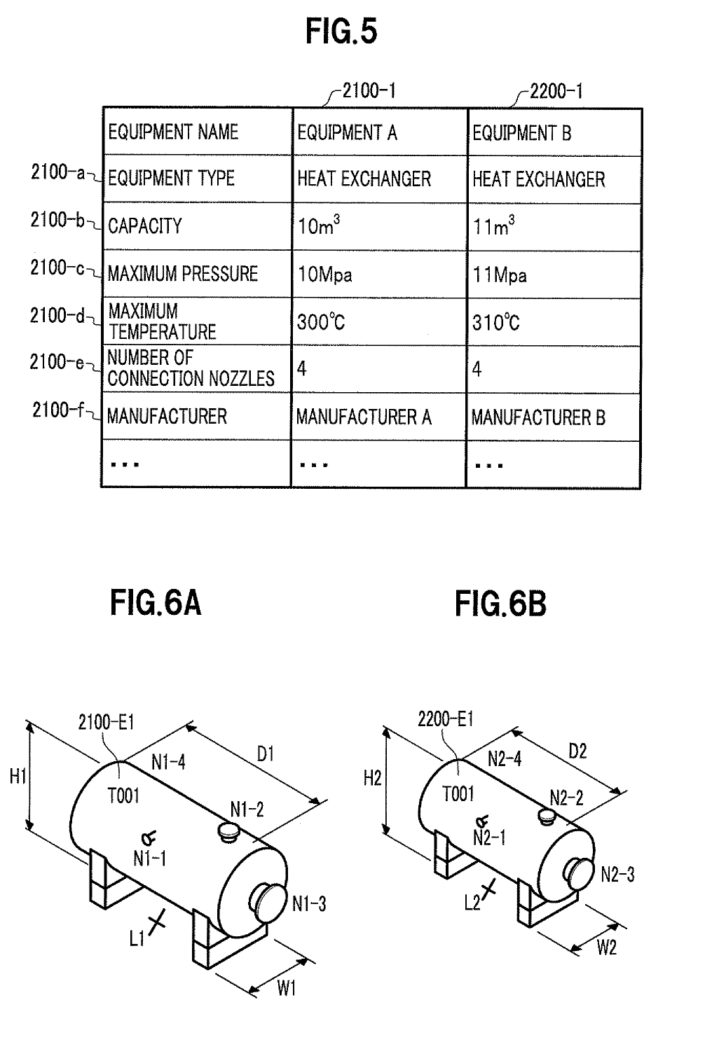

FIG. 5 is a diagram indicating examples of equipment specifications which are used in the determination of similarity of equipment arrangement. The similarity in the equipment specification between the already-constructed plant and the plant to be newly constructed is determined to be higher when the degree of match in the values and characters of the equipment type 2100-a, the capacity 2100-b, the maximum pressure 2100-c, the maximum temperature 2100-d, the number of connection nozzles 2100-e, the manufacturer of the equipment 2100-f, and other information items are higher. When the equipment A (2100-1) belongs to the already-constructed plant and the equipment B (2200-1) belongs to the plant to be newly constructed, it is possible to determine the similarity on the basis of one or more of the above items constituting the equipment specifications.

FIGS. 6A and 6B are diagrams indicating examples of equipment sizes and coordinates of installation positions which are used in the judgement of similarity of equipment arrangement. In the processing using the information indicated in FIGS. 6A and 6B, the dimension parameters such as the depths (D1, D2), the heights (H1, H2), and the widths (W1, W2), the numbers and positions of nozzles (N1-1, N1-2, N1-3, N1-4, N2-1, N2-2, N2-3, N2-4), and the coordinates of the origins of the installation positions (L1, L2) of the pieces of equipment are compared between the already-constructed plant (2100-E1) and the plant to be newly constructed (2100-E2) by the processing of FIG. 4, and the similarity in the shape and arrangement of the equipment is determined. In practice, it is possible to determine the similarity on the basis of one or more of the above items of the dimension parameters, the number and positions of nozzles, and the coordinates of the origin of the installation position.

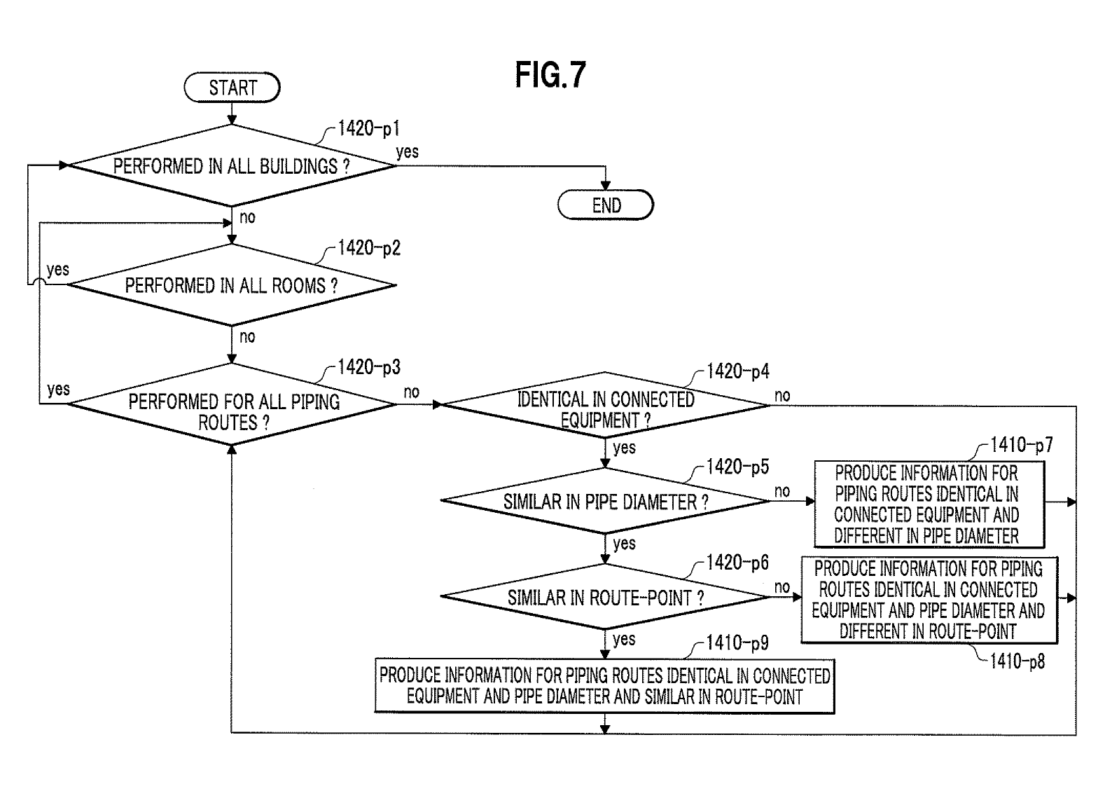

### 3. COMPARISON OF PIPING ROUTE FOR SIMILARITY (FIGS. 7 TO 9)

FIG. 7 is a flow diagram indicating a flow of processing for determining the similarity in the piping route. In the processing of FIG. 7, the operations for all piping routes (in the loop beginning from step 1420-p3) in all rooms (in the loop beginning from step 1420-p2) in all buildings (in the loop beginning from step 1420-p1) are performed, so that the piping routes are sorted into the following three groups 1) to 3):

1) piping routes which are identical in the connected equipment and similar in both of the pipe diameter and the route-point information (through steps 1420-p4, -p5, and -p6);

2) piping routes which are identical in the connected equipment, similar in the pipe diameter, and different in the route-point information (through steps 1420-p4, -p5, and -p6); and

3) piping routes which are identical in the connected equipment and different in the pipe diameter and the route-point information (through steps 1420-p4, and -p5).

Then, the 3-D similarity comparison unit 140 produces for each of the above groups information defining a different way of use of the installation progress data (in steps 1420-p9, -p8, or -p7).

Alternatively, the similarity may be determined on the basis of one or more of the connected equipment, the pipe diameter, and the route-point information. In addition, the similarity may be determined on the basis of whether or not each of the connected equipment, the pipe diameter, and the route-point information falls within a predetermined range, or by use of a predetermined function.

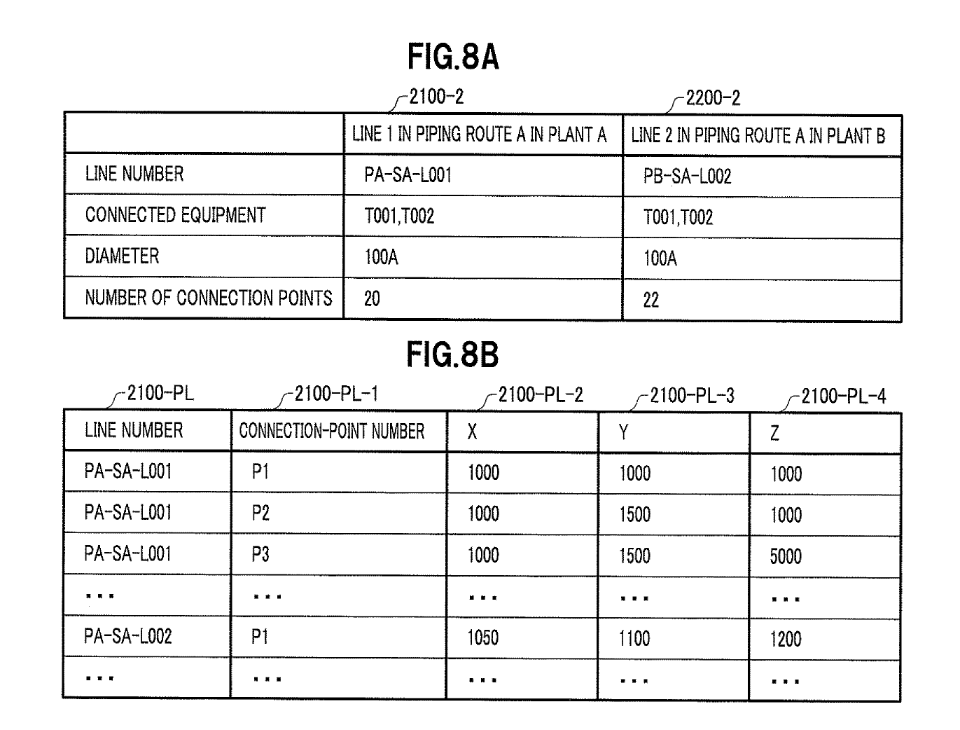

FIGS. 8A and 8B are diagrams indicating examples of piping-route numbers and piping specifications which are used in the determination of similarity of piping routes. In the examples indicated in FIGS. 8A and 8B, a line 1 in a piping route A in a plant A (2100-2) and a line 2 in a piping route A in a plant B (2200-2) are compared. The connected equipment, the diameter, and the number of connection points are summarized in a tabular form for use in the comparison. In addition, the three-dimensional coordinates (2100-PL-2, 2100-PL-3, 2100-PL-4) of the connection points in the line 1 in the piping route A in the plant A (2100-2) are recorded as connection-point information in a database in association with combinations of the line numbers (2100-PL) and the connection-point numbers (2100-PL-1). Similarly, the three-dimensional coordinates (2100-PL-2, 2100-PL-3, 2100-PL-4) of connection points in the line 2 in the piping route A in the plant B (2200-2) are also recorded as connection-point information in the database (although the data for the connection points P2 and P3 are not indicated in FIGS. 8A and 8B). The connection-point information for the already-constructed plant and the connection-point information for the plant to be newly constructed are compared. When a connection point in the already-constructed plant exists within a predetermined distance Δ from a connection point in the plant to be newly constructed, it is determined that a connection point in the already-constructed plant exists within a vicinity of the connection point in the plant to be newly constructed, and the evaluation value of the similarity is increased.

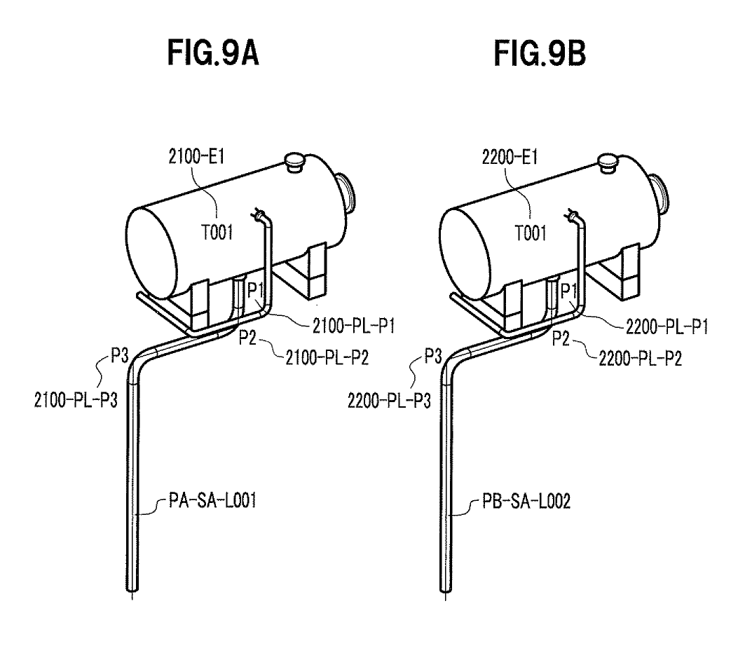

FIGS. 9A and 9B are diagrams illustrating examples of three-dimensional arrangement of the connection points (explained with reference to FIGS. 8A and 8B) which are used for determination of similarity of the piping routes based on the equipment numbers of the pieces of equipment connected to the piping routes. The line PA-SA-L001 connected to the tank 2100-E1 illustrated in FIG. 9A corresponds to the line 1 in the piping route A in the plant A indicated by the reference 2100-2 in FIG. 8A, and the line PB-SA-L002 connected to the tank 2200-E1 illustrated in FIG. 9B corresponds to the line 2 in the piping route A in the plant B indicated by the reference 2200-2 in FIG. 8A. Both of the tank 2100-E1 in the plant A illustrated in FIG. 9A and the tank 2200-E1 in the plant B illustrated in FIG. 9B has the name “T001”.

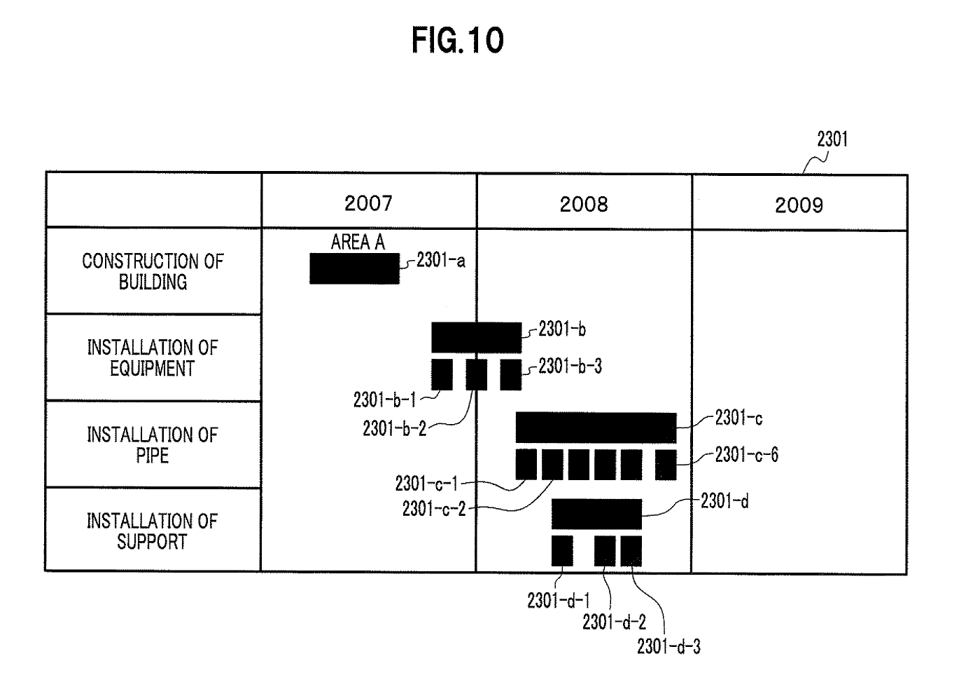

### 4. PROCESSING FOR EXTRACTING INSTALLATION PROGRESS DATA (FIGS. 10 TO 12)

FIG. 10 is a diagram illustrating an example of installation progress data 2301 obtained during construction of an already-constructed plant. After a building and a room (area A) are constructed (in the time span 2301-a), operations for installing equipment, piping, and supports inside the room are started. In the installation progress data 2301, the piping and the supports are installed (respectively in the time spans 2301-c and 2301-d) after the equipment is installed (in the time spans 2301-b). Further, in the case where the piping is broken down into installation units (pipe spools) respectively installed in the time spans 2301-c-1, 2301-c-2, . . . , 2301-c-6, it is possible to obtain detailed progress data, and therefore consider a detailed installation sequence when an installation schedule is produced. In addition, the progress in the equipment installation and the progress in the installation of the supports are also recorded in detail. That is, the progress in the equipment installation is recorded in installation units (respectively installed in the time spans 2301-b-1, 2301-b-2, and 2301-b-3), and the progress in the installation of the supports is recorded in installation units (respectively installed in the time spans 2301-d-1, 2301-d-2, and 2301-d-3).

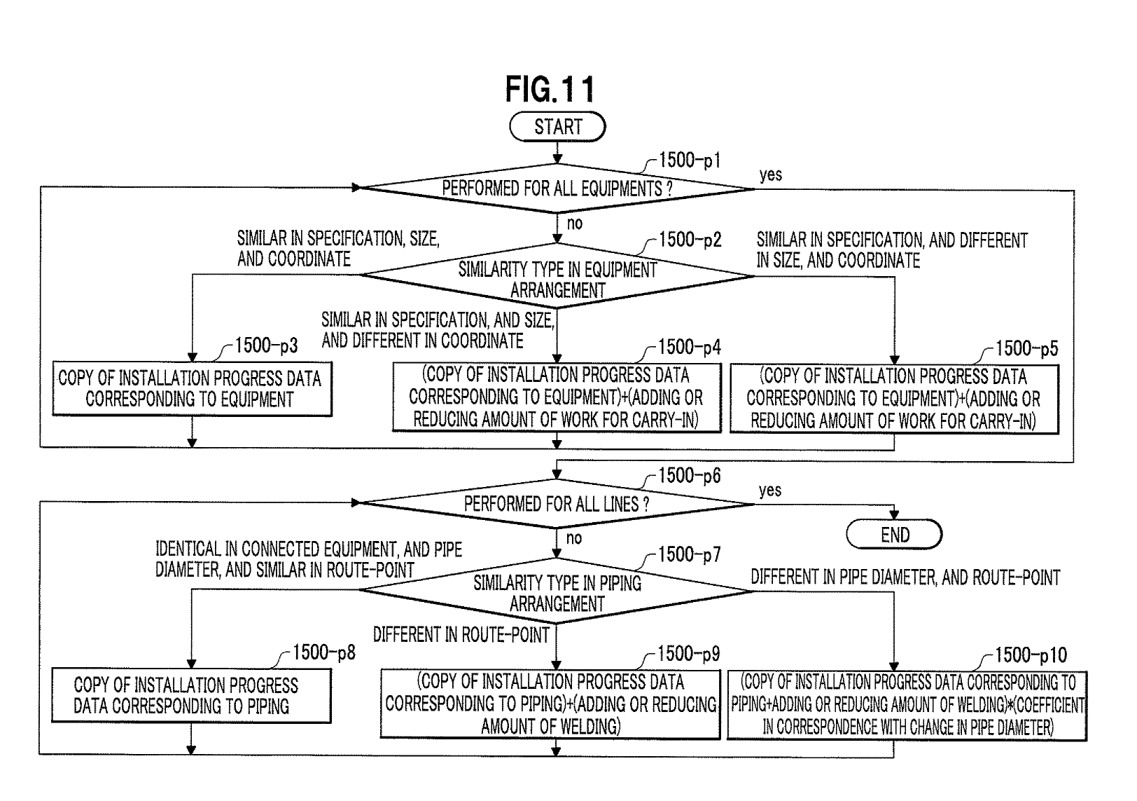

FIG. 11 is a diagram indicating a flow of processing performed by the progress-data extraction unit 150 for selecting one or more portions of the installation progress data. On the basis of the information obtained by the processing indicated in FIG. 4 for determining the similarity in the equipment arrangement and the processing indicated in FIG. 7 for determining the similarity in the piping route, the manner of production of installation schedule data for the plant to be newly constructed is determined (in steps 1500-p1, 1500-p2, 1500-p6, and 1500-p7 in FIG. 11) to be one of the following three manners 1) to 3).

1) The installation schedule data for the plant to be newly constructed is produced on the basis of a copy of the installation progress data (in step 1500-p3 or 1500-p8).

2) The duration of and the resource (mainly the manpower) for the activity are controlled by adding or reducing the amount of work for carry in and welding to or from the installation progress data (in step 1500-p4, 1500-p5, or 1500-p9).

3) The duration of and the resource for the activity are controlled by multiplication of a coefficient in correspondence with a change in the pipe diameter or the like (in step 1500-p10).

FIG. 12 is a diagram illustrating an example of selection of one or more portions of the installation progress data by using grouping of 3-D parts. The part-activity association unit 130 receives settings to bring the 3-D database 210 on the already-constructed plant into correspondence with the database 230 on the installation progress data, and produces a table which indicates a group of 3-D parts (a group of 3-D-part numbers) in correspondence with each activity number, for example, as illustrated on the upper part in FIG. 12. That is, this table includes data of the correspondence between the 3-D model of the already-constructed plant (i.e., the 3-D already-existing model) and the installation progress data. When the above table is produced, the table may be recorded in either of the 3-D database 210 on the already-constructed plant and the database 230 on the installation progress data. The progress-data extraction unit 150 extracts one or more portions of the installation progress data for use in production of an installation schedule for the plant to be newly constructed, on the basis of the information indicating the determined similarity in the 3-D parts of the already-constructed plant and the plant to be newly constructed, by using the above data of the correspondence between the 3-D already-existing model and the installation progress data. For example, portions of the installation progress data are extracted as illustrated in the lower part of FIG. 12. In an exemplary case where the already-constructed plant A (indicated in FIG. 8A) is similar to the plant B to be newly constructed (indicated in FIG. 8A) in the tank A and the piping component connected to the tank A, the progress-data extraction unit 150 can extract from the database 230 on the installation progress data portions of the installation progress data corresponding to the activity numbers of the tank A and piping component connected to the tank A by reference to the table including the data of the correspondence between the 3-D already-existing model and the installation progress data.

The progress-data extraction unit 150 produces the installation schedule data for the 3-D new-construction model by assigning one or more extracted portions of the installation progress data to the installation schedule data for the 3-D new-construction model. The produced installation schedule data is recorded in the schedule database 250 without being processed by the schedule combining unit 160, the validity confirmation unit 170, or the schedule editor 180 (which are illustrated in FIG. 1).

As explained above, it is possible to produce an installation schedule for a plant to be newly constructed, by determining similar installation positions in an already-constructed plant and a plant to be newly constructed and utilizing an installation sequence and the amount of man-hours for complicated installation of equipment and piping by use of a construction simulation apparatus for producing installation schedule data corresponding to a three-dimensional design model of the plant to be newly constructed, on the basis of a three-dimensional design model and installation progress data of the already-constructed plant. The above construction simulation apparatus includes: a match determination unit which determines similarity in one or more installation positions of one or more of pieces of equipment and piping components in a building between the 3-D already-existing model and the 3-D new-construction model on the basis of comparison of the 3-D already-existing model and the 3-D new-construction model; and a progress selection unit which selects one or more portions of the installation progress data corresponding to one or more matching portions of the 3-D already-existing model, where the one or more matching portions of the 3-D already-existing model are extracted by the match determination unit and respectively match one or more portions of the 3-D new-construction model. In addition, it is possible to automatically produce the installation schedule data for the plant to be newly constructed, on the basis of the installation progress data, contribute to rationalization of the construction scheduling work, and realize robust and highly precise construction planning.

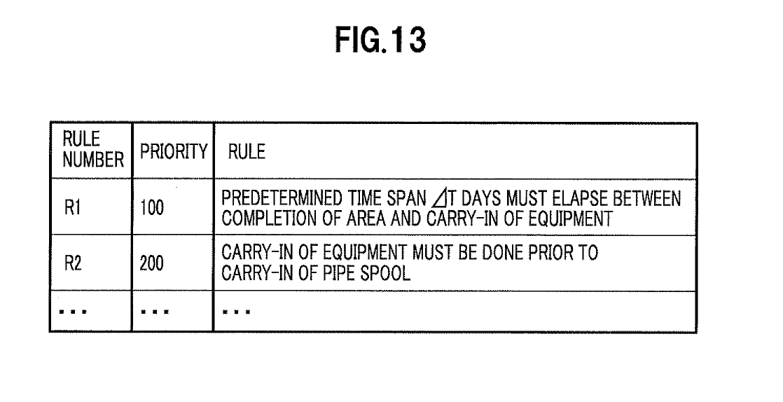

### 5. PROCESSING FOR EXTRACTING INSTALLATION PROGRESS DATA (FIGS. 13 TO 20)

FIG. 13 is a diagram indicating examples of rules which are determined based on empirical knowledge and are used in the selection of the installation progress data. The rules indicated in the table of FIG. 13 are used for determining a chronological relationship between generated activities. In the table of FIG. 13, a description of each rule and data corresponding to the priority of the rule are indicated in association with the rule number. The rules may be obtained in advance, for example, in a heuristic manner. In the case where the order of operations performed by the schedule-pattern determination unit 120 and the schedule combining unit 160 is required to be specified, the installation schedule can be produced by reference to the above rules.

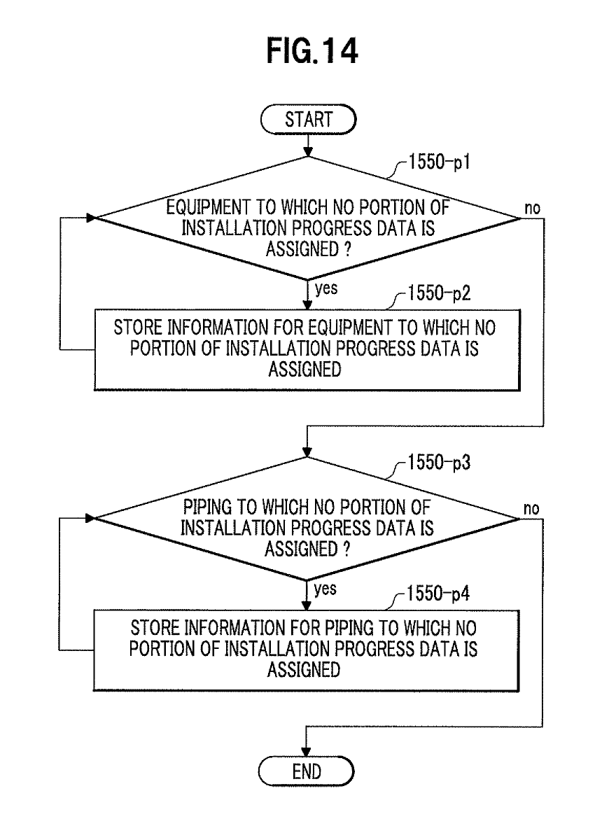

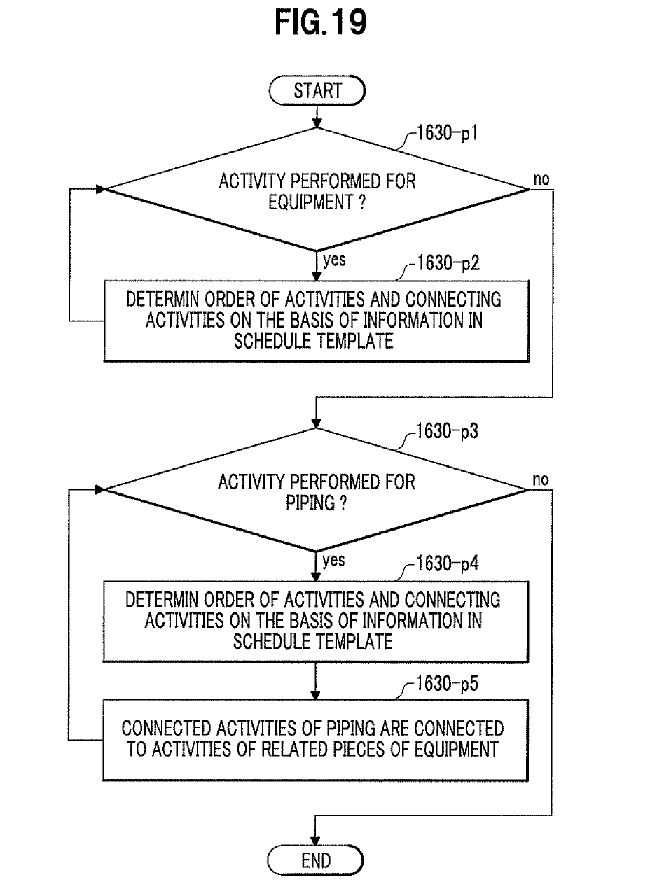

FIG. 14 is a diagram indicating a flow of processing for determining one or more portions of the installation schedule to which no portion of the installation progress data is assigned. In the processing of FIG. 14, data of one or more activities in the one or more portions of the installation schedule to which no portion of the installation progress data is assigned are systematically generated by the construction simulation apparatus. For this purpose, one or more parts of the plant to be newly constructed for which no portion of the installation progress data is assigned are extracted (in steps 1550-p1 and 1550-p3), and information on the extracted portions are temporarily stored (in steps 1550-p2 and 1550-p4) for use in the processing of FIG. 19 for producing the installation schedule.

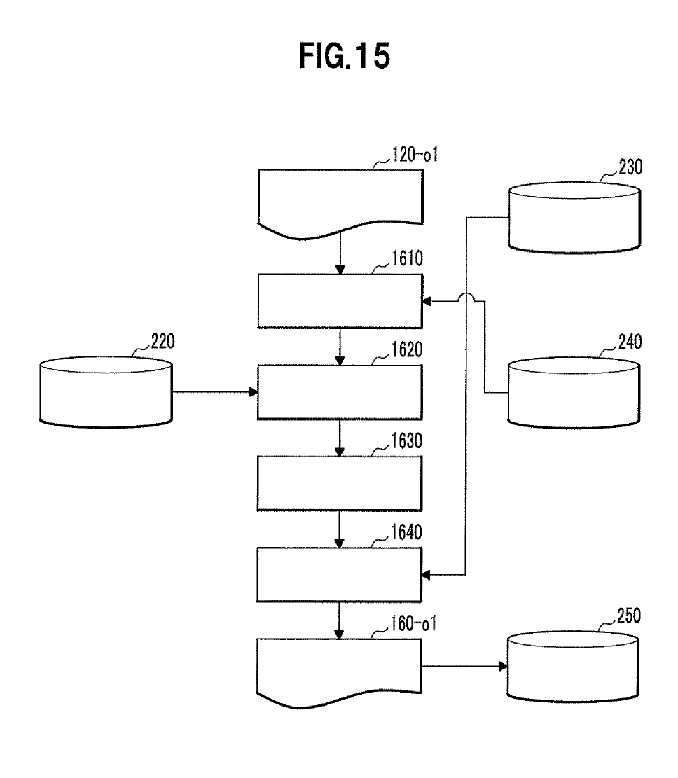

FIG. 15 is a diagram illustrating a configuration of the schedule combining unit 160. The schedule combining unit 160 includes a schedule-template selector 1610, a quantity allocator 1620, a schedule generator 1630, and a schedule combiner 1640. The schedule-template selector 1610 selects a template of the installation schedule on the basis of a result 120-o1 of determination of an installation pattern, which is outputted from the schedule-pattern determination unit 120. The quantity allocator 1620 allocates a quantity for each activity in the selected template, and determines the length of time of the activity. The schedule generator 1630 generates data of one or more partial installation schedules by combining the activities in the selected template. The schedule combiner 1640 combines the one or more portions of the installation progress data selected by the progress-data extraction unit 150 with the data of the one or more partial installation schedules generated by the schedule generator 1630. The output (i.e., the combined installation schedule) 150-o1 of the schedule combiner 1640 is stored in the schedule database 250.

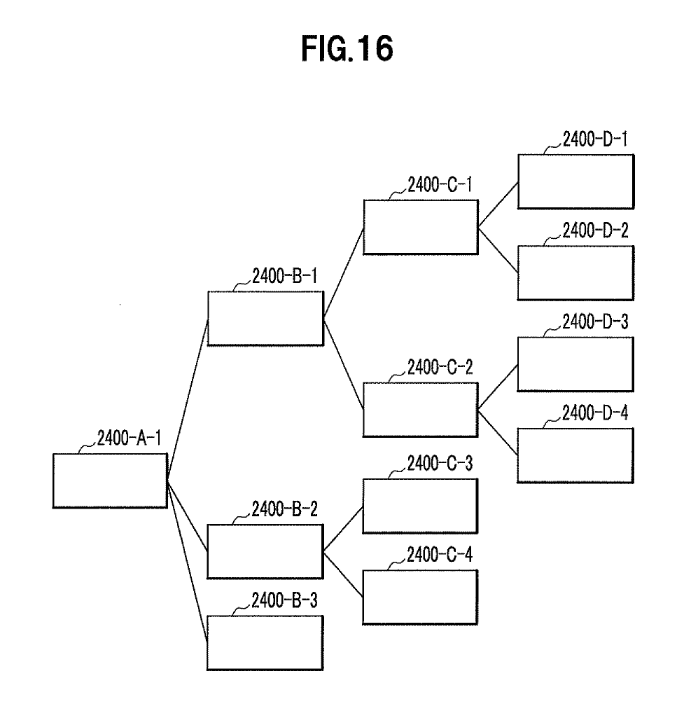

FIG. 16 is a diagram illustrating an example of a WBS (work breakdown structure) template, which is structural information indicating a hierarchy of operations. The WBS is configured so that the ordinal relationship among activities can be handled, and an ordinal relationship among the activities extracted from the installation progress data and the activities generated by the system in the processing of FIG. 14 is specified for use as basic data for producing installation schedule data. For example, the installation work 2400-A-1 includes equipment installation work 2400-B-1, piping installation work 2400-B-2, and support installation work 2400-B-3. The equipment installation work 2400-B-1 includes pump installation work 2400-C-1 and tank installation work 2400-C-2. The piping installation work 2400-B-2 includes pump inlet/outlet piping installation work 2400-C-3 and tank inlet/outlet piping installation work 2400-C-4. The pump installation work 2400-C-1 includes pump-A installation work 2400-D-1 and pump-B installation work 2400-D-2. The tank installation work 2400-C-2 includes tank-A installation work 2400-D-3 and tank-B installation work 2400-D-4. Data indicating an ordinal relationship among the various types of installation work as above is set and stored in a database in advance. In addition, data indicating correspondence relationships between the amount of man-hours and design information on the plant to be newly constructed such as the weights of the respective pieces of equipment, data indicating correspondence relationships between the amount of man-hours and welding points in piping, and other data are also recorded for each type of installation work. For example, data indicating correspondence relationships between the amount of man-hours and the number of components or dimension information may be recorded for each type of installation work. The schedule-template selector 1610 receives the WBS template from the schedule-template database 240.

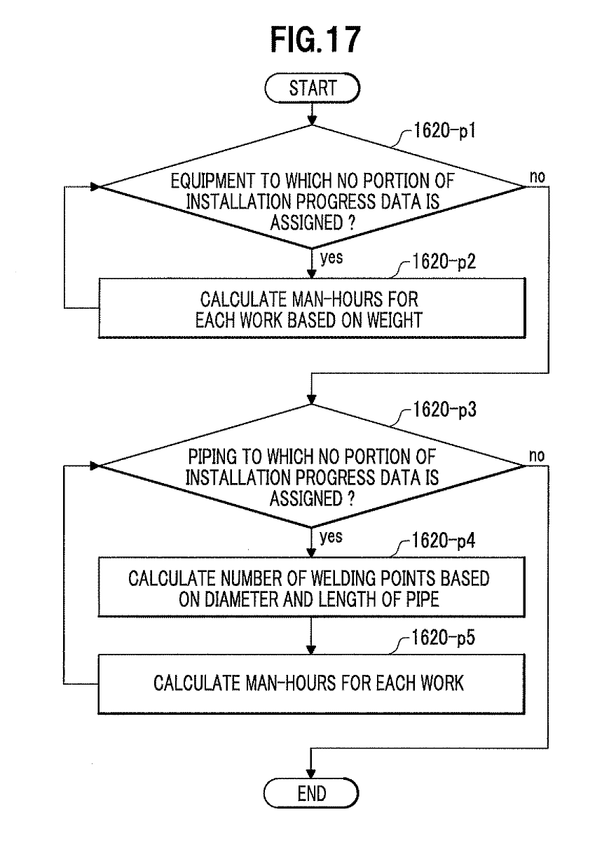

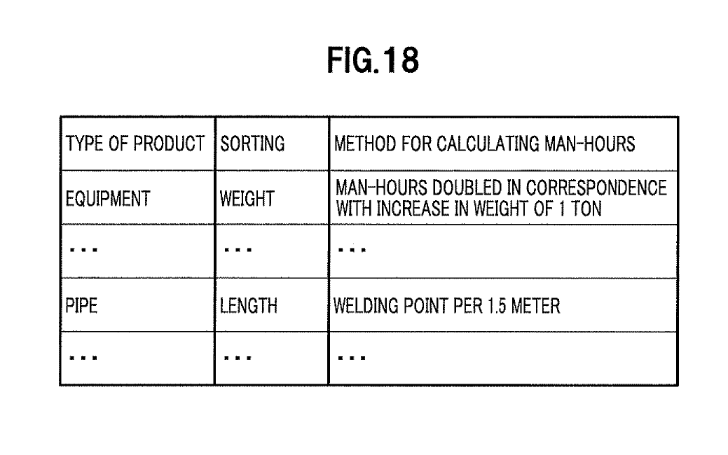

FIG. 17 is a diagram indicating a flow of processing for allocating the quantity. The quantity allocator 1620 allocates a quantity for each activity in the template selected by the schedule-template selector 1610, and determines the length of time of the activity. Before the installation schedule is produced by the construction simulation apparatus according to the present embodiment, the quantity allocator 1620 obtains the amount of man-hours for each of the pieces of equipment (in step 1620-p1) and pipe spools (in step 1620-p3) for which no operation is assigned yet, by automatic man-hour calculation (in steps 1620-p2, 1620-p4, and 1620-p5) using the WBS indicated in FIG. 16 and the quantities corresponding to the activity and being obtained from CAD data. For example, in the man-hour calculation, an operation corresponding to a piece of equipment or a pipe spool for which no operation is assigned yet is extracted from the WBS template. In addition, quantity allocation based on additional man-hour calculation using the auxiliary information which is explained later with reference to FIG. 18 may be performed. Thereafter, in the processing of FIG. 19, one or more partial installation schedules are produced by connecting the activities to which the quantities obtained by the man-hour calculation are allocated. Although the man-hour calculation is performed for both of the equipment and the piping in the processing of FIG. 17, alternatively, the man-hour calculation may be performed for only one of the equipment and the piping.

FIG. 18 is a diagram illustrating the above-mentioned auxiliary information for use in the additional man-hour calculation. For example, the quantity allocator 1620 calculates the amount of increase or decrease in the amount of work which is required in correspondence with increase in the weight or pipe length in the equipment or piping. The auxiliary information indicated as an example in FIG. 18 is supplementary to the aforementioned automatic man-hour calculation, and is stored in the schedule-template database 240.

FIG. 19 is a diagram indicating a flow of processing for production of the installation schedule, which is performed by the schedule generator 1630. The schedule generator 1630 produces the aforementioned one or more partial installation schedules by determining the order of the activities and connecting the activities on the basis of the information in the schedule template. In the processing of FIG. 19, the determination of the order of the activities and the connection of the activities are separately performed for each of the equipment (in steps 1630-p1 and 1630-p2) and the piping (in steps 1630-p3 and 1630-p4), and then the connected activities of the piping are connected to the activities of the related pieces of equipment (in step 1630-p5).

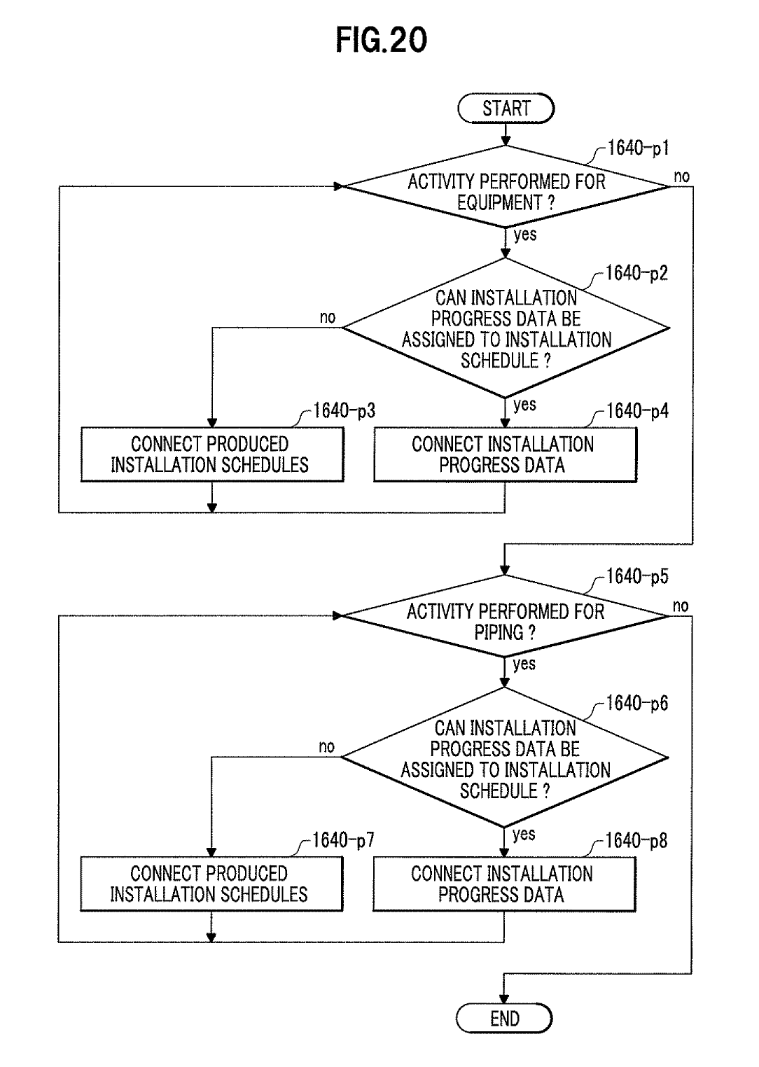

FIG. 20 is a diagram indicating a flow of processing for combining the one or more partial installation schedules, which is performed by the schedule combiner 1640. The schedule combiner 1640 combines the one or more partial installation schedules produced by the schedule generator 1630 with the one or more portions of the installation schedule extracted by the progress-data extraction unit 150 on the basis of the similarity of the parts in the three-dimensional arrangement (in steps 1640-p3, 1640-p4, 1640-p7, and 1640-p8). The processing of FIG. 20 is performed for each of the equipment (in steps 1640-p1 to 1540-p4) and the piping (in steps 1640-p5 to 1540-p8). In the processing of FIG. 20, in order to combine the data of the one or more partial installation schedules and the one or more portions of the installation progress data, a judgement is made as to whether or not the installation progress data can be assigned to each portion of the installation schedule (in steps 1640-p2 and 1640-p6). Thus, the installation schedule for the plant to be newly constructed is completed.

Although the calculation of the similarity and the production and combining of portions of the schedules are explained above for the equipment and the piping, the processing according to the present embodiment can also be generally applied to installation of other parts of a plant (such as a power generation plant) including the piping supports, electric cable trays, air conditioning ducts, and the like.

As explained above, the construction simulation apparatus according to the present embodiment includes a progress-unassigned-portion determination unit, a schedule generation unit, and a schedule-data combining unit. The progress-unassigned-portion determination unit extracts as one or more unassigned portions one or more portions of the 3-D new-construction model not matching the 3-D already-existing model, on the basis of the determination by the aforementioned match determination unit. The schedule generation unit generates one or more partial installation schedules for the one or more portions of the 3-D new-construction model for which no portion of the installation progress data can be assigned, on the basis of the work breakdown structure of a standard installation schedule for equipment and piping and the amount of man-hours calculated by use of design information for the 3-D new-construction model. The schedule-data combining unit combines the portions of the installation progress data selected by the aforementioned progress selection unit with the output of the schedule generation unit so as to produce installation schedule data for the 3-D new-construction model. Therefore, it is possible to produce the installation schedule including the portions in which the installation progress data cannot be used.

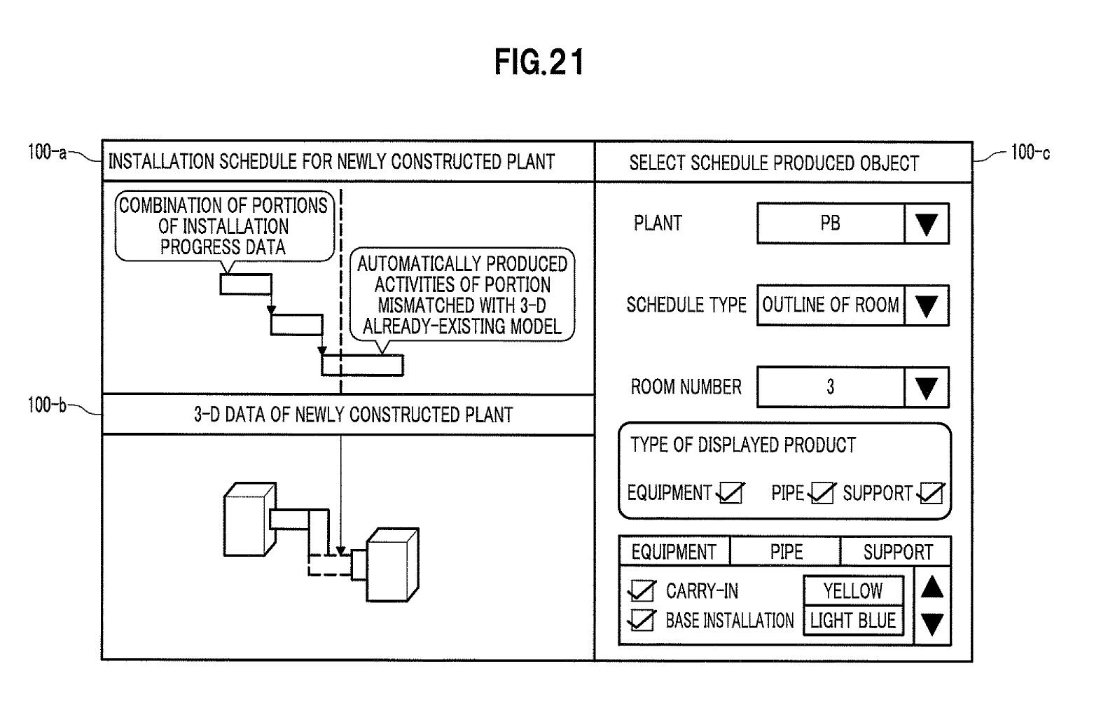

### 6. VISUALIZATION OF PRODUCED SCHEDULE (FIG. 21)

FIG. 21 is a diagram illustrating an example of a screen for displaying an installation schedule produced by the combining. The construction simulation apparatus further includes an output unit which outputs information to be displayed, to the screen of the input/output device 100. The operator makes choices for the objective plant, the schedule type, the room number, the type of the displayed product, the operation (such as “Carry In” or “Base Installation”) on the area 100-c which is displayed for selection of an object for which the schedule is to be produced, through the input/output device 100. Then, the construction simulation apparatus produces the installation schedule for the plant to be newly constructed, and displays the produced installation schedule on the area 100-a which is provided for display of the installation schedule for the plant to be newly constructed. At this time, the construction simulation apparatus displays the activities produced by a combination of portions of the installation progress data and the activities which cannot be produced with portions of the installation progress data because of the mismatch with the 3-D new-construction model and are automatically produced, in such a manner that the activities produced by a combination of portions of the installation progress data are distinguished from the automatically produced activities. In addition, the construction simulation apparatus displays the correspondence between each activity and a corresponding portion of the three-dimensional data of the plant to be newly constructed, on the area 100-b which is provided for display of the three-dimensional data of the plant to be newly constructed. When the parts related to the produced installation schedule are displayed on a 3-D CAD system, the construction simulation apparatus according to the present embodiment enables distinguished display of the parts installed by the automatically produced activities and the parts installed by the activities produced by a combination of portions of the installation progress data. Therefore, it is possible to increase the efficiency in the operation of confirming the produced installation schedule.

### 7. VARIOUS FUNCTIONS OF CONSTRUCTION SIMULATION APPARATUS

The validity confirmation unit 170 reads the installation progress data from the schedule database 250, and milestone data from the milestone database 260. The milestone data is data defining constraints imposed on the installation schedule. For example, constraint data defining constraints on milestone activities the delay of which is not permitted, constraint data defining constraints imposed on the ordinal relationship among activities in the installation schedule, and other constraint data are recorded in advance as the milestone data. In addition, data defining spatial constraints based on the 3-D CAD may be recorded. The validity confirmation unit 170 performs processing for comparing the corresponding operations and CAD data with the constraint data in order to confirm whether or not the constraints are satisfied. Further, the validity confirmation unit 170 may prompt the operator to confirm the validity by displaying the installation schedule data and the milestone data on the interface illustrated in FIG. 21.

As explained above, the construction simulation apparatus according to the present embodiment can include a schedule-milestone validity judgement unit and an installation-space validity judgement unit, and the schedule-milestone validity judgement unit can include an installation-order validity judgement unit, where the schedule-milestone validity judgement unit judges whether or not the installation schedule data produced by the schedule combining unit 160 satisfies constraints imposed on the installation schedule and defined by the milestone data which is preset, the installation-space validity judgement unit judges whether or not installation is possible, on the basis of data which defines constraints and is preset, by using a space as a sum of installation spaces generated from three-dimensional models of two or more of pieces of equipment and piping components, and the installation-order validity judgement unit judges the validity of the installation schedule on the basis of milestone data defining constraints on the order of installation operations. The construction simulation apparatus having the schedule-milestone validity judgement unit, the installation-space validity judgement unit, and the installation-order validity judgement unit can automatically confirm the validity of the installation schedule on the basis of the constraints on the milestones on the installation schedule, the constraints on the installation spaces in the three-dimensional space, and the constraints on the order of the activities. Alternatively, the construction simulation apparatus may have one or more of the schedule-milestone validity judgement unit, the installation-space validity judgement unit, and the installation-order validity judgement unit.

The construction simulation apparatus can support the operator for correction of the installation schedule by displaying data of activities exceeding milestone time limits as distinguished from the other activities. The construction simulation apparatus includes the 3-D database 220 (on the plant to be newly constructed) in which CAD data of the plant to be newly constructed is recorded, the schedule database 250 in which the installation schedule data corresponding to the CAD data of the plant to be newly constructed is recorded, and the milestone database 260 in which time-limit data defining the time limits of milestone activities the delay of which is not permitted is recorded. The construction simulation apparatus can support the operator for correction of the installation schedule by performing a construction simulation method. In construction simulation method, the installation schedule data from the schedule database 250, and the time-limit data from the milestone database 260 are read out, and portions of the installation schedule data corresponding to the activities which exceed the milestone time limits are displayed as distinguished from the other portions of the installation schedule data.

In addition, the construction simulation apparatus may read out the CAD data from the 3-D database 220 (illustrated in FIG. 15) on the plant to be newly constructed, and display portions of the CAD data corresponding to the activities which exceed the milestone time limits as distinguished from the other portions of the CAD data, on the basis of the correspondence relationship between the CAD data of the plant to be newly constructed and the installation schedule data, where the correspondence relationship are produced by the schedule generator 1630 on the basis of the CAD data. In other words, when the construction simulation apparatus performs the construction simulation method further including the step of displaying the portions of the CAD data corresponding to the activities which exceed the milestone time limits, as distinguished from the other portions of the CAD data, by use of the correspondence relationship between the CAD data of the plant to be newly constructed and the installation schedule data in the schedule database 250, it is possible to recognize the quantities after expiration of the milestone time limits on the basis of the CAD data, and recognize the degree of necessity of the correction on the CAD system.

The schedule editor 180 reads out the installation schedule data from the schedule database 250, reads out the CAD data from the 3-D database 220 on the plant to be newly constructed, and displays the installation schedule data in association with the CAD data through the interface illustrated in FIG. 21. The operator can edit the installation schedule through the input/output device 100. In the editing, information on the background of the installation schedule is added to activities, where the activities are the minimum units constituting the installation schedule. The information on the background of the installation schedule is information related to each activity. For example, the information on the background of the installation schedule is a memorandum of the operator. The provision of the function of editing the installation schedule enables change of the installation schedule into a more realistic one on the basis of the operator's judgement. In addition, when the functions according to the present invention are applied to the editing of the installation schedule, it is possible to efficiently confirm the validity of the edited installation schedule, and increase the efficiency in the cycle of operations including the production of the installation schedule, the validity confirmation, and the correction by re-editing.

As explained above, in the case where the construction simulation apparatus includes an output means which displays the portions of the installation schedule corresponding to the installation progress data on the three-dimensional CAD display system in a color different from the other portions of the installation schedule, the portions of the installation schedule generated from the installation progress data can be distinguished from the portions of the installation schedule automatically generated by the system. Thus, the efficiency in the operation for confirming the produced installation schedule can be increased.

In addition, in the case where the construction simulation apparatus includes a schedule editor which adds to the activities (as the minimum units constituting the installation schedule) information on the background of the installation schedule, the construction simulation apparatus enables change of the installation schedule into a more realistic one on the basis of the operator's judgement. Further, when the functions according to the present invention are applied to the editing of the installation schedule, it is possible to efficiently confirm the validity of the edited installation schedule, and increase the efficiency in the cycle of operations including the production of the installation schedule, the validity confirmation, and the correction by re-editing.

Further, although, in the above explanations, the processing by the schedule-pattern determination unit 120 and the schedule combining unit 160 is a prerequisite to the operations of the validity confirmation unit 170 and the schedule editor 180, alternatively, the operations of the validity confirmation unit 170 and the schedule editor 180 can be performed as long as the data generated in the processing by the schedule-pattern determination unit 120 and the schedule combining unit 160 are stored.

In addition to the provision explained above, the construction simulation apparatus according to the present invention may further include a schedule production means and an installation-procedure visualization means, where the schedule production means searches three-dimensional databases and schedule databases for one or more portions of CAD data of a previous design which partially match CAD data of the current design in equipment, piping, and weld points, and combines portions of installation schedule data for the previous design corresponding to the matching portions of the CAD data of the previous design so as to produce a new installation schedule for the current design. Specifically, in order to realize the schedule production means and the installation-procedure visualization means, the construction simulation apparatus according to the present invention may include: a means for extracting correspondence relationships between parts data in a three-dimensional model of an already-constructed plant and minimum operational units (activities) in the installation progress data for the already-constructed plant, on the basis of the three-dimensional models (data of geometric shapes) and attribute data which are generated by the 3-D CAD system and stored in the 3-D database on the already-constructed plant and the 3-D database on the plant to be newly constructed; a means for extracting the similarity in the installed equipment between the already-constructed plant and the plant to be newly constructed, on the basis of the attributes, the coordinates of installed positions, and the like; a means for extracting the similarity in the installed piping route between the already-constructed plant and the plant to be newly constructed, on the basis of the attributes, the coordinates of installed positions (e.g., the degree of match between the center lines of pipes), and the like; a means for extracting one or more portions of the installation progress data corresponding to one or more matching pieces of equipment and piping routes; a means for determining one or more portions of an installation schedule which cannot be generated from the installation progress data and to which no operation is assigned yet, and generating installation schedule data not corresponding to the installation progress data; and a means for producing installation schedule data for the plant to be newly constructed, by connecting the extracted portions of the installation progress data and the installation schedule data not corresponding to the installation progress data.

In addition, the construction simulation apparatus according to the present invention may include a means for confirming the validity of the produced installation schedule on the basis of milestones of the installation schedule, noninterference in the three-dimensional space, and constraints on the order of operations.

Further, the construction simulation apparatus according to the present invention may include a means for displaying the portions of the installation schedule corresponding to the installation progress data on the three-dimensional CAD display system in a color different from the other portions of the installation schedule.

Moreover, the construction simulation apparatus according to the present invention may include a means for editing the installation schedule produced by the combining, and a means for adding to the activities (as the minimum units constituting the installation schedule) information on the background of the installation schedule.

### 8. ADDITIONAL MATTERS

Each of the structures, the functions, the processing units, the processing means, and the like described above, in its entirety or in part, may be realized by hardware, for example, one or more integrated circuits. Alternatively, the structures, the functions, the processing units, the processing means, and the like described above each may be realized by software, i.e., by a processor which interprets and executes a program describing each of the functions per se or the function of each of the structures, the processing units, the processing means, and the like. Information or data for realizing each of the above functions including programs, tables, files, and the like can be stored in one or more storage devices such as memories, HDDs (hard disk drives), or SSDs (solid-state drives) or in one or more storage mediums such as IC (integrated circuit) cards, SD (secure digital) memory cards, or DVDs (digital versatile discs). Thus, each of the structures, the functions, the processing units, the processing means, and the like can be realized by a processor or a program module.

The present invention is not limited to the embodiment described above, and various variations can be included in the scope of the present invention. For example, the above embodiment is described in detail for easy understanding of the present invention, and the embodiment is not necessarily limited to the construction having all of the structures and the functions disclosed in this specification. In addition, it is possible to add some structure to a portion of the configuration of the embodiment, replace a portion of the configuration of the embodiment with some structure, or remove a portion of the configuration of the embodiment.

The lines for control and information are indicated in the accompanying drawings only for the purpose of explanation, and the accompanying drawings do not necessarily indicate all the lines for control and information which are actually arranged in the products in the market. It is possible to consider that almost all the constituents of the disclosed embodiment can be considered to be interconnected in the actual products.

### 9. INDUSTRIAL USABILITY

The present invention can be applied to construction work for power generation plants such as thermal or nuclear power plants. In addition, in the case where three-dimensional CAD data and electronic schedule data are introduced in an early stage, the present invention can be applied to the fields in which a precise construction schedule is required to be produced in a short time.

What is claimed is:

1. A construction simulation apparatus comprising:
a first database in which a three-dimensional design model of an already-constructed plant is recorded as a 3-D already-existing model;
a second database in which installation progress data in the already-constructed plant is recorded;
a third database in which a three-dimensional design model of a plant to be newly constructed is recorded as a 3-D new-construction model;
a match determination unit which compares the 3-D already-existing model and the 3-D new-construction model, and determines one or more portions of the 3-D already-existing model respectively matching one or more portions of the 3-D new-construction model in one or more installation positions of one or more of pieces of equipment and piping components, to be one or more matching portions of the 3-D already-existing model; and
a progress selection unit which selects, as data of one or more portions of an installation schedule corresponding to one or more portions of the 3-D new-construction model, one or more portions of the installation progress data corresponding to the one or more matching portions of the 3-D already-existing model, on the basis of data indicating a correspondence relationship between the 3-D already-existing model and the installation progress data.

2. The construction simulation apparatus according to claim 1, further comprising a progress-unassigned-portion determination unit which extracts as one or more progress-unassigned portions of the 3-D new-construction model one or more portions of the 3-D new-construction model not matching the 3-D already-existing model, a partial-schedule generation unit which generates one or more partial installation schedules for one or more portions of the 3-D new-construction model for which no portion of the installation progress data can be assigned, on the basis of structural information indicating a hierarchy of operations for installation of at least one of equipment and piping in a standard installation schedule and an amount of man-hours calculated by use of design information corresponding to the 3-D new-construction model, and an installation-schedule-data combining unit which combines the one or more portions of the installation progress data selected by the progress selection unit and the one or more partial installation schedules generated by the partial-schedule generation unit so as to produce data of the installation schedule for the 3-D new-construction model.

3. The construction simulation apparatus according to claim 2, further comprising a schedule-milestone validity judgement unit which judges whether or not the data of the installation schedule produced by the installation-schedule-data combining unit satisfies constraints imposed on the installation schedule and defined by milestone data which is preset.

4. The construction simulation apparatus according to claim 1, further comprising an installation-space validity judgement unit which judges whether or not installation is possible, on the basis of data which defines constraints and is preset, by using a space as a sum of installation spaces generated from three-dimensional models of two or more of the pieces of equipment or the piping components.

5. The construction simulation apparatus according to claim 3, wherein the schedule-milestone validity judgement unit includes an installation-order validity judgement unit which judges validity of the installation schedule on the basis of milestone data defining constraints on an order of installation operations.

6. The construction simulation apparatus according to claim 1, further comprising an output means which displays the one or more portions of the installation schedule corresponding to the one or more portions of the installation progress data on a three-dimensional CAD display system in a color different from other portions of the installation schedule so that the one or more portions of the installation schedule is distinguished from the other portions of the installation schedule, when the installation schedule is produced.

7. The construction simulation apparatus according to claim 1, further comprising a schedule editor which adds information on a background of the installation schedule to activities, which are minimum units constituting the installation schedule.

8. A construction simulation method executed by a construction simulation apparatus including a first database in which a three-dimensional design model of an already-constructed plant is recorded as a 3-D already-existing model, a second database in which installation progress data in the already-constructed plant is recorded, and a third database in which a three-dimensional design model of a plant to be newly constructed is recorded as a 3-D new-construction model, said construction simulation method comprising the steps of:
comparing the 3-D already-existing model and the 3-D new-construction model, and determining one or more portions of the 3-D already-existing model respectively matching one or more portions of the 3-D new-construction model in one or more installation positions of one or more of pieces of equipment and piping components, to be one or more matching portions of the 3-D already-existing model; and
selecting, as data of one or more portions of an installation schedule corresponding to one or more portions of the 3-D new-construction model, one or more portions of the installation progress data corresponding to the one or more matching portions of the 3-D already-existing model, on the basis of data indicating a correspondence relationship between the 3-D already-existing model and the installation progress data.

9. The construction simulation method according to claim 8, further comprising the steps of,
extracting as one or more progress-unassigned portions of the 3-D new-construction model one or more portions of the 3-D new-construction model not matching the 3-D already-existing model, on the basis of the similarity determined in the step of determining,
generating one or more partial installation schedules for one or more portions of the 3-D new-construction model for which no portion of the installation progress data can be assigned, on the basis of structural information indicating a hierarchy of operations for installation of at least one of equipment and piping in a standard installation schedule and an amount of man-hours calculated by use of design information corresponding to the 3-D new-construction model, and
combining the one or more portions of the installation progress data selected in the step of selecting and the one or more partial installation schedules generated in the step of generating so as to produce data of the installation schedule for the 3-D new-construction model.

10. The construction simulation method according to claim 9, further comprising the step of judging whether or not the data of the installation schedule produced in the step of combining satisfies constraints imposed on the installation schedule and defined by milestone data which is preset.

11. The construction simulation method according to claim 8, further comprising the step of judging whether or not installation is possible, on the basis of data which defines constraints and is preset, by using a space as a sum of installation spaces generated from three-dimensional models of two or more of the pieces of equipment and the piping components.

12. The construction simulation method according to claim 10, wherein the step of judging includes a step of judging validity of the installation schedule on the basis of milestone data defining constraints on an order of installation operations.

13. The construction simulation method according to claim 8, further comprising the step of displaying the one or more portions of the installation schedule corresponding to the one or more portions of the installation progress data on a three-dimensional CAD display system in a color different from other portions of the installation schedule so that the one or more portions of the installation schedule is distinguished from the other portions of the installation schedule, when the installation schedule is produced.

14. The construction simulation method according to claim 8, further comprising the step of adding information on a background of the installation schedule to activities, which are minimum units constituting the installation schedule.

15. A construction simulation method executed by a construction simulation apparatus including a 3-D database in which CAD data of a plant to be newly constructed is recorded, a schedule database in which data of an installation schedule corresponding to the CAD data of the plant to be newly constructed is recorded, and a milestone database in which data of one or more milestone time limits for one or more operations which are not permitted to be delayed is recorded, said construction simulation method comprising the steps of:
reading the data of the installation schedule from the schedule database;
reading the data of the one or more milestone time limits from the milestone database; and
displaying one or more portions of the installation schedule in which excess over the one or more milestone time limits occurs, as distinguished from other portions of the installation schedule.

16. The construction simulation method according to claim 15, wherein one or more portions of the CAD data of the plant to be newly constructed which correspond to the one or more portions of the installation schedule are displayed as distinguished from other portions of the CAD data, by use of a correspondence relationship between the data of the installation schedule which is recorded in the schedule database and the CAD data of the plant to be newly constructed which is recorded in the 3-D database.
